(19) United States
(12) Patent Application Publication
(10) Pub. No.: US 2013/0187429 A1
(43) Pub. Date: Jul. 25, 2013

(54) APPARATUS AND METHOD FOR MANUFACTURING UPHOLSTERED FURNITURE USING REINFORCED BOARD SUCH AS CORRUGATED BOARD

(71) Applicant: Manuel Almanza Guerrero, Pickering (CA)

(72) Inventor: Manuel Almanza Guerrero, Pickering (CA)

(21) Appl. No.: 13/354,921

(22) Filed: Jan. 20, 2012

(51) Int. Cl. A47C 7/02; B68G 7/00; A47C 7/16

(52) U.S. Cl. 297/452.18; 29/91.1

(57) ABSTRACT

The disclosure herein relates to upholstered furniture and methods of manufacturing upholstered furniture from reinforced board such as corrugated board. The method includes assembling a frame from reinforced board, securing an upholstery support member to the reinforced board, covering the frame with upholstery, and securing the upholstery to the upholstery support member.

### FIELD

This specification relates to furniture, and particularly to upholstered furniture made from reinforced board such as corrugated board.

### BACKGROUND

The following paragraphs are not an admission that anything discussed in them is prior art or part of the knowledge of persons skilled in the art.

Upholstered furniture is often made with wood or metal frames. These materials, however, can often have an adverse environmental impact, for example, due to the consumption of wood and metals. Furthermore, wood or metal frames can also be expensive to manufacture and can make the furniture heavy and difficult to move. Heavier furniture also tends to be more expensive to transport, for example, due to increased fuel costs. The increase in fuel usage for transportation can also adversely affect the environment.

Some pieces of furniture have frames made from corrugated cardboard. This furniture can be less expensive, lighter, and better for the environment. However, furniture made from corrugated cardboard generally does not include upholstery because traditional upholstering techniques utilize staples and other upholstery fasteners that might puncture or otherwise damage the corrugated cardboard.

### INTRODUCTION

In an aspect of this specification, there is a method of manufacturing upholstered furniture. The method includes assembling a frame from reinforced board, securing an upholstery support member to the reinforced board, covering the frame with upholstery, and securing the upholstery to the upholstery support member.

The method may also include selecting the upholstery support member to be made from a wood product. For example, the wood product may be medium-density fiberboard. The method could also include selecting the upholstery support member to be made from a rubber product.

In some examples, the securing step may include securing a strip of material along an edge of the reinforced board.

In some examples, the upholstery support member may be secured to the portion of the frame using an adhesive. For example, the adhesive may be glue.

In some examples, the upholstery may be secured to the upholstery support member using staples.

The method may also include positioning a layer of padding between the upholstery and upholstery support member prior to securing the upholstery to the upholstery support member.

In some examples, the frame may include a support surface formed from the reinforced board. Furthermore, the upholstery may include padding over the support surface. Further still, the method may include forming at least one opening in the reinforced board along the support surface so as to provide ventilation to the padding.

In some examples, assembling the frame may include cutting and folding the reinforced board. Cutting and folding the reinforced board may include passing the reinforced board across at least one forming die having at least one forming blade. The forming blade could be a folding blade for creasing the reinforced board along a fold line. The forming blade could also be a cutting blade for cutting the reinforced board.

In some examples, the reinforced board may include an exterior wall to be covered with the upholstery, and an interior wall opposite the exterior wall. Furthermore, the reinforced board may be passed across the forming die such that the forming blade strikes the interior wall.

In some examples, the reinforced board may be a corrugated board, and the exterior wall may have B-fluting, and the interior wall may have C-fluting.

In some examples, at least one of the exterior wall and the interior wall may have a hollowed core filled with a reinforcement having a honeycomb pattern.

In some examples, the forming die may include at least one pressure relief member positioned adjacent to the forming blade.

In some examples, the furniture may be assembled from a plurality of components having frames made from reinforced board.

In another aspect of this specification, there is a piece of upholstered furniture. The upholstered furniture includes a frame made from reinforced board, at least one upholstery support member secured to the reinforced board, upholstery covering the frame, and at least one upholstery fastener for securing the upholstery to the upholstery support member.

In some examples, the upholstery support member may be made from a wood product. For example, the wood product may be medium-density fiberboard. The upholstery support member could also be made from a rubber product.

In some examples, the upholstery support member may include a strip of material positioned along an edge of the reinforced board.

In some examples, the frame may include a support surface formed from the reinforced board. Furthermore, the upholstery may include padding over the support surface. Further still, the reinforced board may have at least one opening along the support surface for providing ventilation to the padding.

The piece of furniture may also include adhesive for securing the upholstery support member to the reinforced board.

In some examples, the reinforced board may be double walled.

In some examples, the reinforced board may be a corrugated board. Furthermore, the corrugated board may include an exterior wall with a B-fluting and an interior wall with a C-fluting.

In some examples, the corrugated board may include at least one liner sheet made from a paper-like product having an areal density greater than about 285 g/m². The corrugated board could also include at least one wall with fluting made from a paper-like product having an areal density of less than about 145 g/m².

In some examples, the reinforced board may include at least one wall having a hollowed core filled with a reinforcement having a honeycomb pattern.

In some examples, the at least one upholstery fastener may include a plurality of staples.

The piece of furniture could also include a layer of padding positioned between the upholstery and the upholstery support member.

In yet another aspect of this specification, there is a component for use in upholstered furniture. The component includes a frame made from reinforced board, and at least one upholstery support member secured to the reinforced board for receiving at least one upholstery fastener so as to secure upholstery to the upholstery support member.

In some examples, the upholstery support member may be made from a wood product. For example, the wood product may be medium-density fiberboard. The upholstery support member could also be made from a rubber product.

In some examples, the upholstery support member may include a strip of material positioned along an edge of the reinforced board.

The component may also include adhesive for securing the upholstery support member to the reinforced board.

In some examples, the reinforced board may be double walled.

In some examples, the reinforced board may be a corrugated board. Furthermore, the corrugated board may include an exterior wall with a B-fluting and an interior wall with a C-fluting.

In some examples, the corrugated board may include at least one liner sheet made from a paper-like product having an areal density greater than about 285 g/m². The corrugated board could also include at least one wall with fluting made from a paper-like product having an areal density of less than about 145 g/m².

In some examples, the reinforced board may include at least one wall having a hollowed core filled with a reinforcement having a honeycomb pattern.

Other aspects and features of the teachings disclosed herein will become apparent, to those ordinarily skilled in the art, upon review of the following description of the specific examples of the specification.

### DRAWINGS

The drawings included herewith are for illustrating various examples of articles, methods, and apparatuses of the present specification and are not intended to limit the scope of what is taught in any way. In the drawings:

FIG. 1 shows a top perspective view of a piece of upholstered furniture having a frame made from corrugated board;

FIG. 2 shows a cross-sectional view of a furniture frame being assembled from two portions of corrugated board being secured together at a corner joint;

FIG. 3 shows a cross-sectional view of the frame of FIG. 2 being covered with upholstery;

FIG. 4 is an exploded perspective view of the frame of FIG. 2 being covered with upholstery;

FIG. 5 is a perspective view of an upholstery support member secured to an edge of the frame of FIG. 2;

FIG. 6 is a perspective view of a furniture frame made from corrugated board having openings for providing ventilation to upholstery padding;

FIG. 7 is a perspective view of a reinforced board for use in making a piece of upholstered furniture;

FIG. 8 is a flow chart illustrating a method of manufacturing upholstered furniture;

FIG. 9 is a top perspective view of an example of a flatbed forming die for use in manufacturing upholstered furniture;

FIG. 10 is a perspective view of an example of a rotary forming die for use in manufacturing upholstered furniture; and

FIG. 11 is an enlarged perspective view of an example of a forming die including pressure relief members adjacent to forming blades.

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

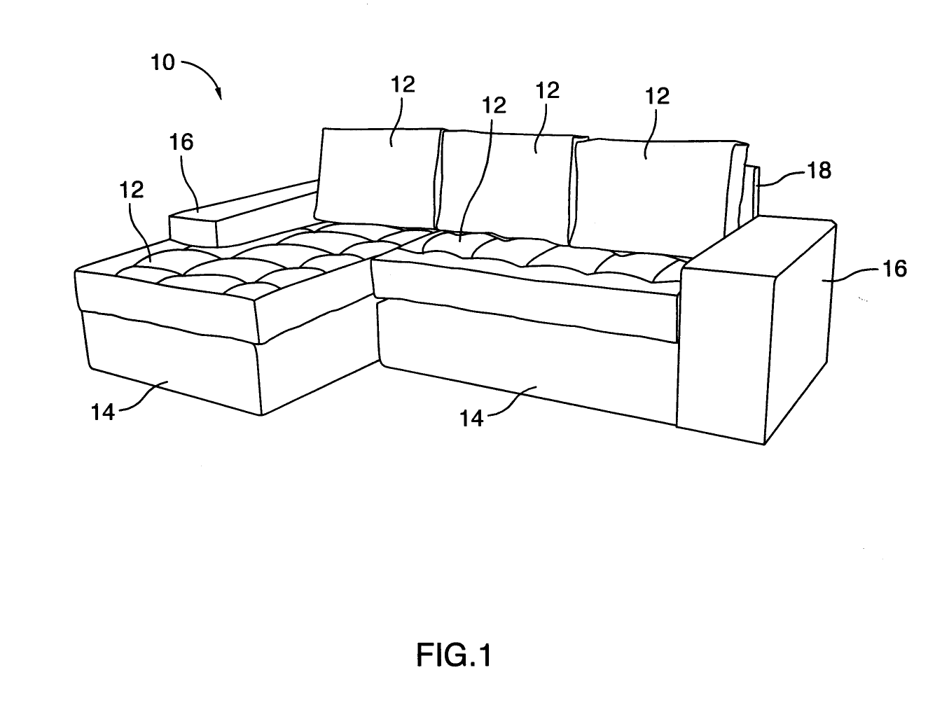

Referring to FIG. 1, there is a piece of upholstered furniture 10, for example, but not limited to, a sectional sofa having cushions 12 thereon. It is to be appreciated, however, that although a sofa is used for purposes of illustration, applicants' teachings are not to be so limited and can apply to other forms of furniture as would be apparent to those skilled in the art. The furniture 10 includes a frame made from reinforced board, and particularly, corrugated board such as corrugated cardboard or corrugated fiberboard. The corrugated board frame can be lighter and less expensive than frames made from wood or metal. Making the frame from corrugated board can also be environmentally friendly, for example, by reducing the consumption of wood and metals and by utilizing recycled (or partly recycled) paper-products to make the corrugated board.

While the illustrated examples generally refer to reinforced board made from paper-products (e.g. corrugated cardboard or corrugated fiberboard), the reinforced board could also be made from other materials such as plastics.

The furniture 10 may be assembled from a plurality of components having frames made from reinforced board, and particularly, corrugated board. For example, as shown in FIG. 1, the sectional sofa may be assembled from a number of components such as one or more seat frames 14, arm frames 16, and back frames 18. Each component may have a frame made from corrugated board. The frame of each component may be assembled to provide a desired shape. For example, each of the components 14, 16, 18 of the sectional sofa of FIG. 1 has a box-like shape. The frame of each component could also have other shapes.

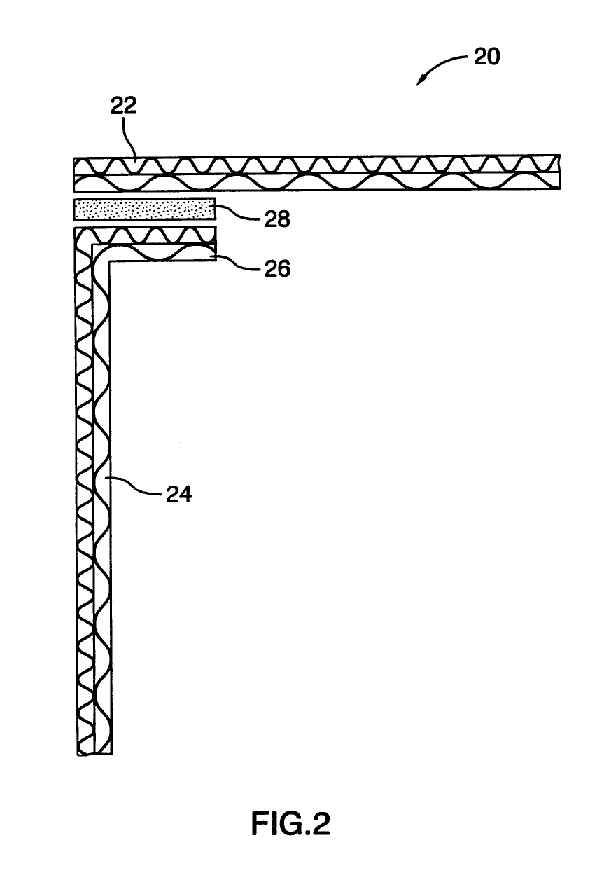

The frame of each component may be assembled by cutting, folding, and securing together one or more pieces of corrugated board. For example, with reference to FIG. 2, a frame 20 of a piece of furniture may be assembled by securing a first portion 22 of corrugated board to a second portion 24 of corrugated board. In some examples, the first and second portions 22, 24 may be portions of the same sheet of corrugated board. The first and second portions 22, 24 could also be parts of separate sheets of corrugated board.

Referring still to FIG. 2, the first portion 22 may have a folded flap 26 secured to the second piece 24 so as to form a corner joint. As shown, the first and second portions 22, 24 may be secured together using an adhesive 28 such as glue or epoxy. The first and second portions 22, 24 could also be secured together in other ways, for example, using tape or stiches.

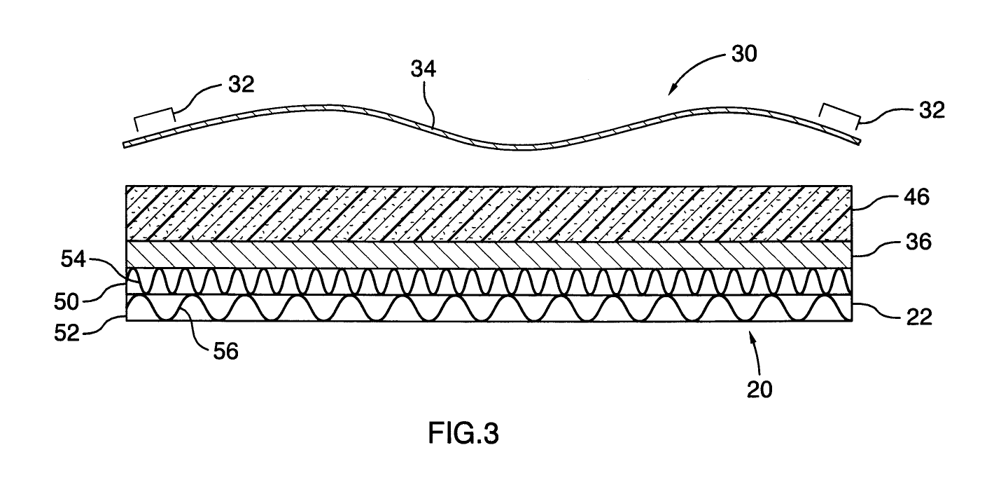

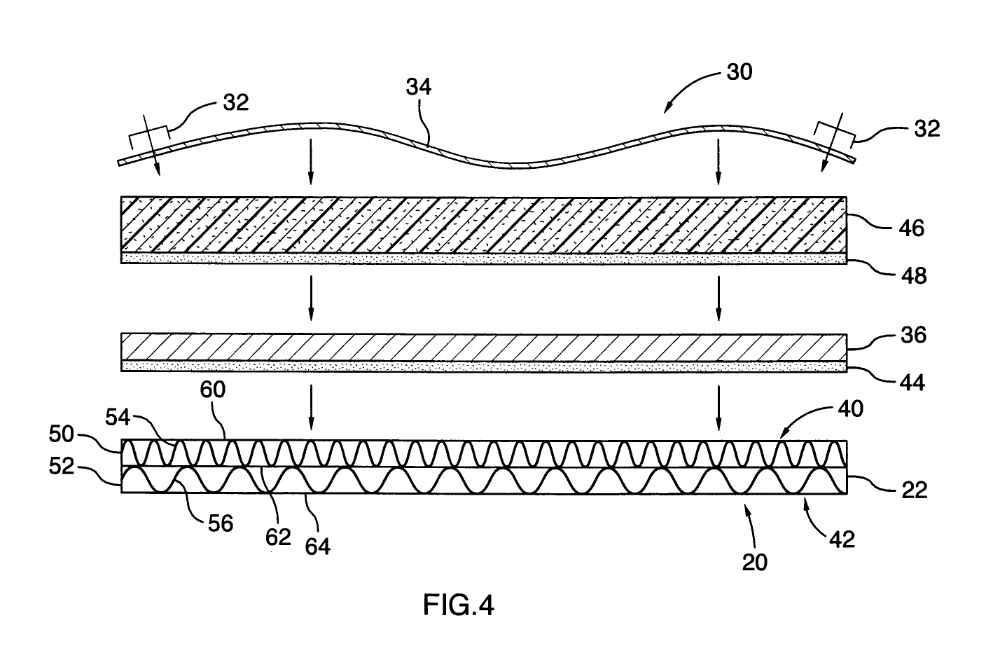

Referring now to FIGS. 3 and 4, the frame 20 may be covered with upholstery 30. For example, as shown in FIG. 4, the corrugated board 22 may have an exterior side 40 covered by the upholstery 30, and an interior side 42 opposite the exterior side 40.

As shown, the upholstery 30 may include a piece of fabric 34, which may be cloth, leather, synthetic leather, natural plant fiber fabrics, paper based fabrics, stone based fabrics, and the like. The upholstery 30 may be secured in place using one or more upholstery fasteners 32 such as staples. The upholstery fasteners 32 could also be upholstery tacks, tacking strips, hook and loop fasteners such as Velcro™, or other types of fasteners.

The furniture 10 also includes one or more upholstery support members 36 secured to the corrugated board 22. The upholstery support members 36 can provide a solid base for receiving the upholstery fasteners 32 so as to secure the upholstery 30 in place. If the upholstery fasteners 32 were directly fastened to the corrugated board 22, the upholstery fasteners 32 might puncture or otherwise damage the frame 20, or the upholstery fasteners 32 might become loose over time and detach from the corrugated board 22.

The upholstery support members 36 can also enhance the strength and rigidity of the frame 20. This may allow the upholstery 30 to be stretched over the frame 20 as is sometimes the case when upholstering furniture.

In some examples, the upholstery support member 36 may be made from a wood product such as medium-density fiberboard (MDF), plywood, hardwood, or softwood. Such wood products may provide a suitable material for securing the upholstery 30 to the upholstery support member 36 using staples or other upholstery fasteners. The upholstery support member 36 could also be made from a rubber product or other materials such as plastic.

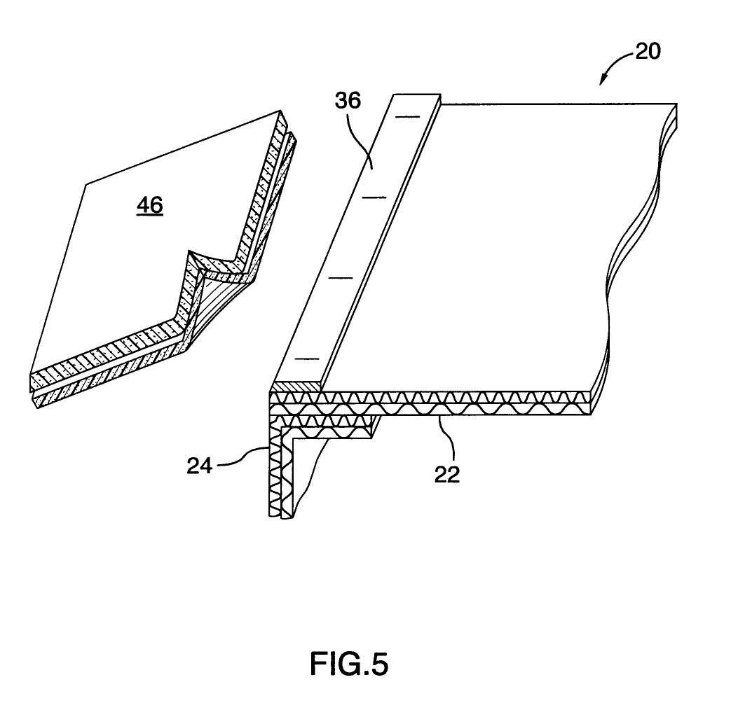

The upholstery support members 36 may be positioned in locations that receive the upholstery fasteners 32. For example, as shown in FIGS. 3 and 4, the upholstery support member 36 may be secured to the exterior side 40 of the corrugated board 22. As shown in FIG. 5, the upholstery support member 36 may be a strip of material (e.g. MDF) positioned along an edge of the corrugated board 22.

In some examples, the upholstery support member 36 may be secured to the frame 20 in a location that will be concealed during use, such as the bottom or back of the furniture. The upholstery support member 36 could also be secured to portions of the frame 20 that will be covered with cushions 12, such as underneath seat bases or seat backs. The upholstery 30 may then wrap around a corner of the furniture to a location that will be visible, such as the top or sides of the furniture.

The upholstery support member 36 may be secured to the corrugated board 22 using an adhesive 44 such as glue or epoxy. For example, the strip of MDF may have an adhesive layer covered by a removable strip that can be peeled off to uncover the adhesive layer.

The upholstery support member 36 could also be secured to the corrugated board 22 using other fasteners such as staples that extend through the corrugated board 22 from the interior side 42 thereof and into the upholstery support member 36. As another example, when the upholstery support member 36 is made from rubber, the upholstery support member 36 can be secured to the corrugated board 22 using stiches.

As described above, the upholstery fasteners 32 could be hook and loop fasteners such as Velcro™, in which case, one part of the hook and loop fasteners may be secured to the upholstery support member 36 (e.g. a sheet of loops glued to the MDF strip), and another part of the hook and loop fasteners may be secured to the upholstery 30 (e.g. a sheet of hooks stitched to the fabric 34). The use of hook and loop fasteners can allow removal of the upholstery 30, for example, to allow interchangeability of fabrics.

In some examples, as shown in FIGS. 3-6, the furniture 10 may include a layer of foam or padding 46 positioned between the fabric 34 and the upholstery support member 36. The padding 46 can help cover and conceal the upholstery support member 36, which might otherwise leave a protruding ridge along the frame 20. The padding 46 can also protect the frame 20 and corrugated board 22 from damage. The padding 46 could be made from foam, natural or synthetic batting, feather or down, and the like. In some examples, the padding 46 may include re-purposed foam, which may be environmentally-friendly.

The padding 46 may be secured in place using the upholstery fasteners 32. The padding 46 could also be secured in place using an adhesive 48 such as glue or epoxy, for example, to hold the padding in place while inserting the upholstery fasteners 32.

In some examples, the padding 46 may be part of the upholstery 30, such as with seat padding or padding for aesthetic purposes. The padding 46 could also be separate from the upholstery 30, and may be made from a different type of material than the upholstery padding, such as foam having a different density.

Referring again to FIGS. 3 and 4, in some examples, the corrugated board 22 may be double walled. For example, the corrugated board 22 may include an exterior wall 50 covered by the upholstery 30, and an interior wall 52 opposite to the exterior wall 50.

While the illustrated example includes a frame 20 made from double walled corrugated board, in some examples, the corrugated board 22 may have any number of walls, including single walled or multi-walled reinforced boards.

Each of the exterior and interior walls 50, 52 may have a hollowed core filled with a reinforcement such as fluting 54, 56 disposed between opposed liner sheets. For example, as shown in FIG. 4, the exterior wall 50 may have a first type of fluting 54 (e.g. disposed between an exterior sheet 60 and an intermediate sheet 62), and the interior wall 52 may have a second type of fluting 56 (e.g. disposed between the intermediate sheet 62 and an interior sheet 64).

In some examples, the first and second types of fluting 54, 56 may be different. For example, the first type of fluting 54 of the exterior wall 50 may be B-fluting, and the second type of fluting 56 of the interior wall 52 may be C-fluting. Each type of fluting may have a particular thickness and a particular number of flutes per unit length, for example, to enhance the strength of the board in particular ways. As an example, the B-fluting may have a thickness of between about 2.5 mm and 3.0 mm, and about 159+/−15 flutes per meter. More particularly, the B-fluting may have about 50+/−2 flutes per 300 mm. Furthermore, the C-fluting may have a thickness of between about 3.5 mm to about 4.0 mm, and about 128+/−10 flutes per meter. More particularly, the B-fluting may have about 50+/−2 flutes per 300 mm.

In some examples, the walls 50, 52 may have other types of fluting such as A-fluting, D-fluting, and the like. Furthermore, in some examples, each wall 50, 52 may have the same type of fluting.

The fluting 54, 56 and the liner sheets 60, 62, 64 may be made from paper-like products such as cardboard, paperboard, stone-based paper such as natural stone paper, and the like. In some examples, the corrugated board 22 may be made from recycled paper products. For example, the corrugated board 22 could be made from purely recycled paper, or a mixture of virgin pulp and recycled paper. Furthermore, the corrugated board 22 could be made from paper manufactured from Canadian-based pulp. The fluting 54, 56 and the liner sheets 60, 62, 64 could also be made from other materials, such as plastic.

In some examples, the fluting 54, 56 and the liner sheets 60, 62, 64 may be made from paper-like products having a particular areal density or weight. For example, the liner sheets 60, 62, 64 may be made from a paper-like product having an areal density of at least about 270 g/m². Furthermore, the areal density of some of the liner sheets 60, 62, 64 may be greater than about 285 g/m², and possibly, less than about 310 g/m². More particularly, the exterior sheet 60 may be made from paper having an areal density of about 307 g/m², the intermediate sheet 62 may be made from paper having an areal density of about 276 g/m², and the interior sheet 64 may be made from paper having an areal density of about 296 g/m². Furthermore, the fluting 54, 56 may be made from a paper-like product having an areal density of less than about 145 g/m², and more particularly, an areal density of between about 110 g/m² and about 140 g/m². More particularly still, the areal density of the fluting may be about 126 g/m². Manufacturing the corrugated board using paper-like products having these areal densities can provide a cost effect corrugated board that meets requirements for use in North American climates.

In some examples, the furniture 10 may include a surface coating applied to the corrugated boards. The coating may be selected to provide moisture-resistance, or to reduce flammability of the corrugated board. In some examples, the coating may include a starch or an oxidized polyethylene.

The coating may be applied to the fluting or liner sheets. The coating can be applied before, during, or after the corrugated board is made. For example, the coating could also be applied directly onto source paper for making the fluting and liner sheets. The coating could also be mixed into raw pulp that ultimately forms the source paper.

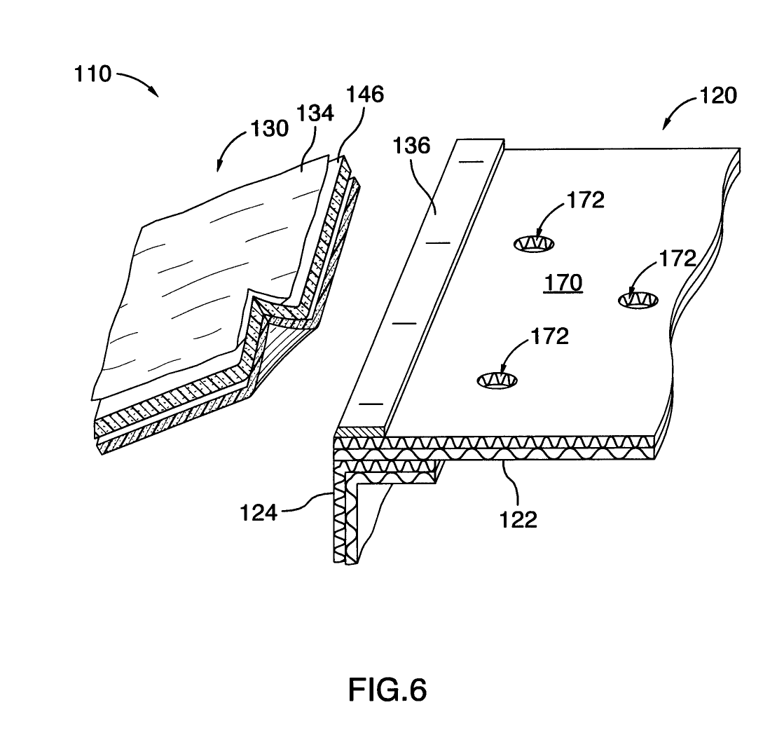

Referring now to FIG. 6, there is a component 110 of a piece of furniture, such as, for example, but not limited to, a chair. The component 110 is similar in many respects to the components of the piece of furniture 10 described above and similar elements are given similar reference numerals incremented by one hundred. For example, the component 110 includes: a frame 120 made from one or more reinforced boards (such as corrugated boards 122, 124); one or more upholstery support members 136 secured to the reinforced board; upholstery 130 for covering the frame 120; and one or more upholstery fasteners (not shown).

As shown, the upholstery 130 may include a piece of fabric 134 and padding 146 between the fabric 134 and the frame 120. The padding 146 could be foam, feather, down, polyester, and the like.

In some examples, the frame 120 may include a seat 170 formed from the corrugated board 122. For example, the seat may be a seat-base or a seat-back for support someone sitting on the furniture. Furthermore, the upholstery may include foam or padding 146 over the seat 170. In such examples, the corrugated board 122 may have one or more openings 172 along the seat for providing ventilation to the padding 146. The openings 172 can allow air to escape from inside the frame 120, for example, when someone sits down or when any pressure is otherwise applied to the padding 146. Without the openings 172, the fabric 134 might inflate when someone sits down because the air within the padding 146 might be trapped without any place to escape. The size, number and pattern of the openings 172 may be selected to provide sufficient ventilation while maintaining structural integrity of the frame.

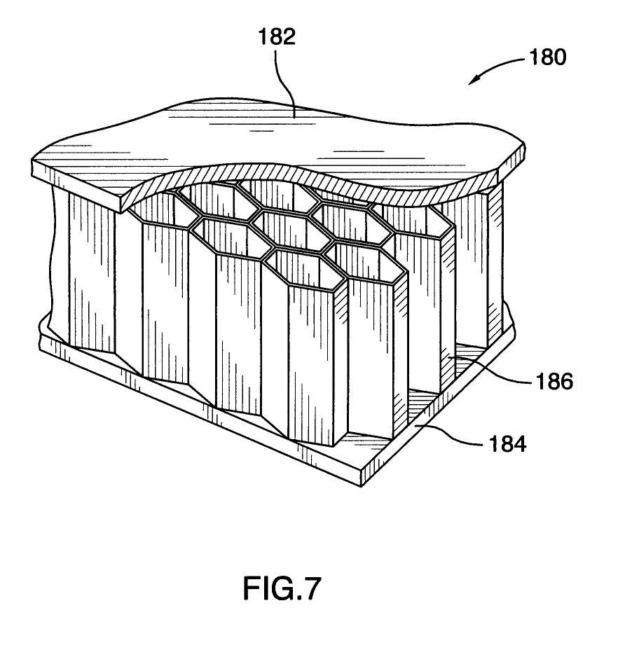

While the examples described above generally refer to furniture made from corrugated board having fluting, in some examples, the furniture may be made from reinforced board having other configurations. For example, with reference to FIG. 7, there is a reinforced board 180 including a single wall formed by two liner sheets 182, 184 and a hollowed core therebetween. As shown, the hollowed core may be filled with a reinforcement 186 having a honeycomb pattern. In some examples, the reinforcement 186 could have other patterns, such as a diamond pattern, a square pattern, and the like. The reinforced board 180 can be used to make upholstered furniture as described above.

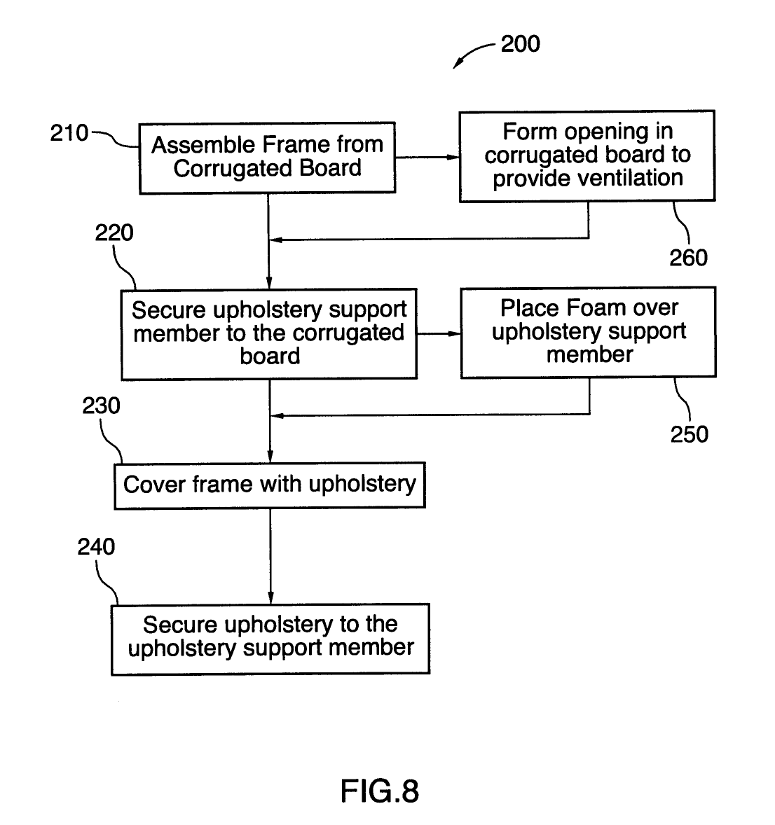

Referring now to FIG. 8, there is a method 200 of manufacturing upholstered furniture. The method 200 includes steps 210, 220, 230, and 240.

Step 210 includes assembling a frame from reinforced board such as corrugated board. For example, step 210 may include cutting, folding, and securing one or more pieces of corrugated board together to form the frame. In some examples, the furniture may be assembled from a number of components, each of which may have its own frame made from reinforced board such as corrugated board.

The assembly of the frame may include manufacturing the corrugated board. The manufacturing process may include corrugating sheets of raw material (e.g. source paper), which may include new or recycled paper products (such as kraft liners or test liners). During the corrugation process, the sheets of raw material may be softened, for example, using high pressure steam. Flutes can then be formed in the sheets, for example, by passing the sheets over a geared wheel. Two liner sheets can then be joined to opposing sides of the fluted sheet to form a single walled corrugated board. Additional liner sheets and fluted sheets can be added to provide a multi-walled corrugated board. For example, the corrugated board may be double walled and may including an exterior wall having a first type of fluting (e.g. B-fluting) and an interior wall having a second type of fluting (e.g. C-fluting).

If the corrugated board will be coated, the coating can be applied to the sheets of raw material before, during or after the corrugation process.

After forming the corrugated board, the board may be dried to remove moisture. For example, the corrugated board may rest for a period of at least 24 hours in order to dry.

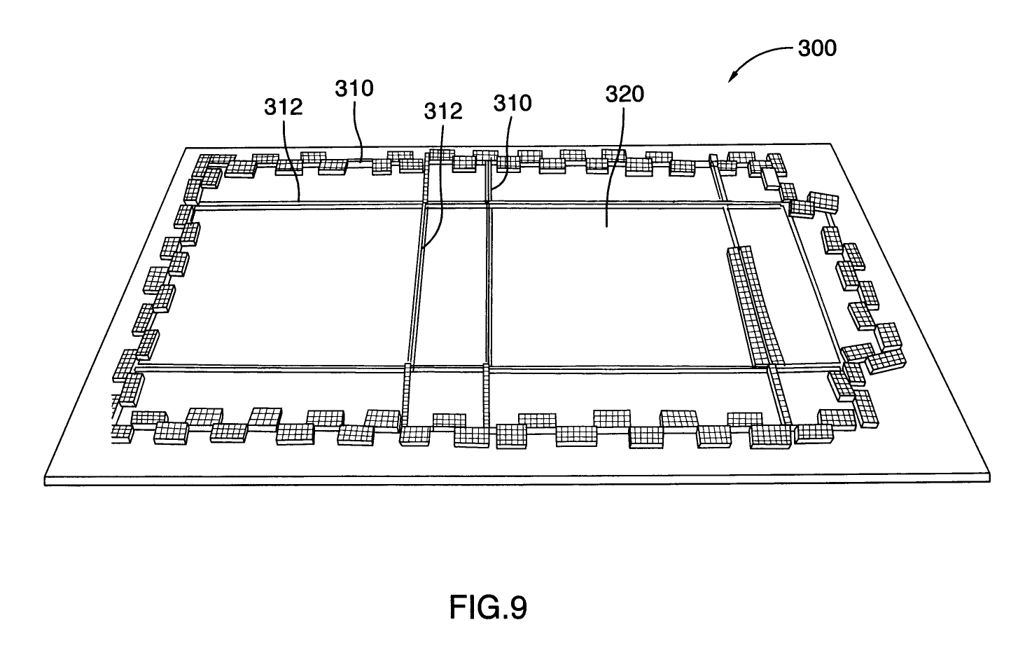

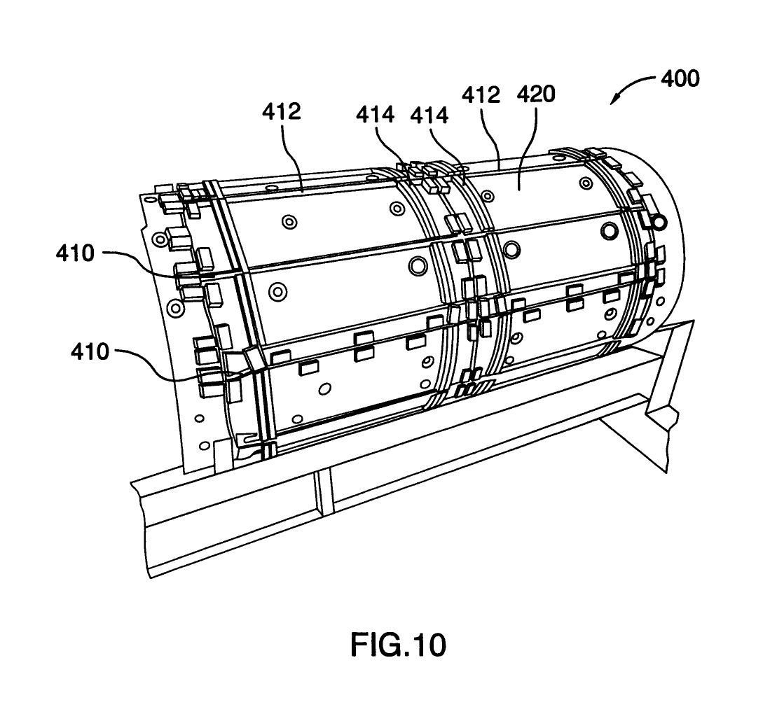

Subsequently, the corrugated board can be cut and folded to form the frame. With reference to FIGS. 9 and 10, cuts and folds may be made by passing the corrugated board across a forming die having one or more forming blades. For example, as shown in FIG. 9, the forming die could be a flatbed forming die 300, which may include one or more straight forming blades 310, 312 mounted to a base such as a wooden board 320. As another example, as shown in FIG. 10, the forming die could be a rotary forming die 400, which may include one or more straight forming blades 410, 412 and one or more circular forming blades 414 mounted to a base such as a rotatable drum 420.

Some of the forming blades can be configured to cut the corrugated board. For example, as shown in FIGS. 8 and 9, some of the forming blades may be cutting blades 310, 410 (e.g. sharp blades) for cutting the corrugated board. In some examples, the cutting blades may have a thickness of between about 0.6 mm and 1.6 mm, a height of between about 15 mm and 27 mm. The cutting blades could also have smaller or larger dimensions. The cutting blades may be made from carbon steel or another suitable material, such as metals, ceramics, and the like.

Some of the forming blades could also be configured to mark the corrugated board with a fold line. For example, as shown in FIGS. 8 and 9, some of the forming blades could be folding blades 312, 412 for creasing, scoring or otherwise marking the corrugated board along the fold line. The folding blade may have the same general dimensions and material construction as the cutting blade. One difference is that the folding blade is dulled or rounded so as to avoid cutting the corrugated board.

In some examples, the corrugated board may be multi-walled and may include an exterior wall and an interior wall. Furthermore, the corrugated board may be passed across the forming die such that the forming blade strikes the interior wall. This may reduce the likelihood of cracking or otherwise damaging the exterior wall, which could degrade the appearance or structural integrity of the furniture.

Typically, pressure is applied to the corrugated board as it is passed across the forming die, for example, using a platen press or a roller press. The amount of pressure applied may be selected based on the type of corrugated board being used, the particular machine or die used, and whether the board is to be cut or marked with fold lines. The amount of pressure applied should be limited so as to avoid damaging the corrugated board.

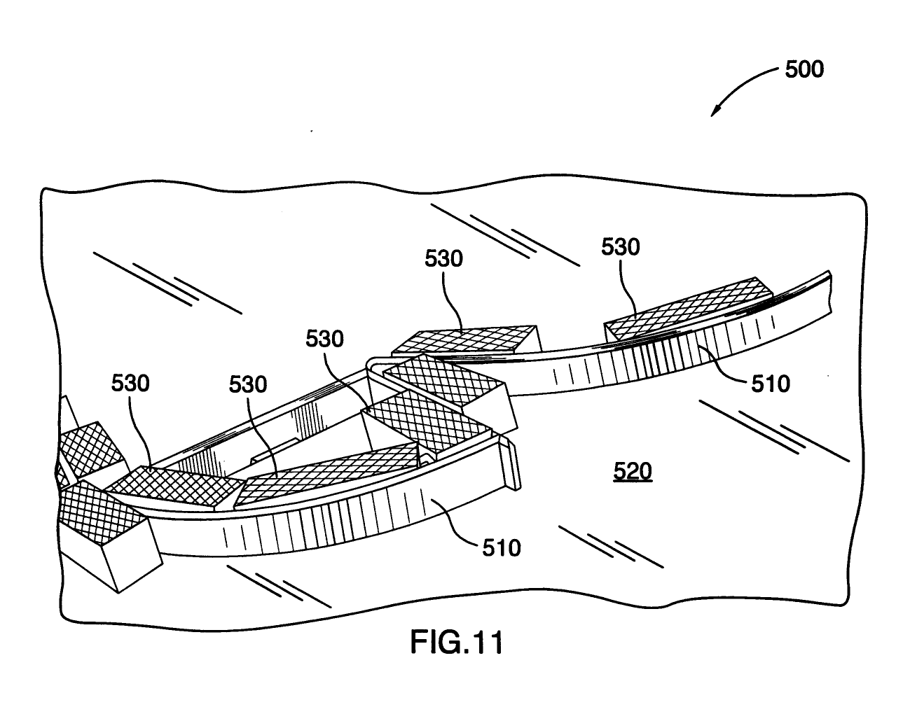

In some examples, the forming die may include features that help to reduce or distribute pressure applied to the corrugated board while forming the cuts or fold lines. For example, with reference to FIG. 11, there is an example of a forming die 500, which includes a plurality of forming blades 510 (e.g. cutting or folding blades) mounted to a base 520 (such as a wooden board). As shown, the forming die 500 may include pressure relief members 530 positioned adjacent to the forming blades 510. The pressure relief members 530 may be made from a compressible material such as rubber and may be mounted to the base 520, for example, using an adhesive. The pressure relief members 530 can help reduce the likelihood of damaging the corrugated board, for example, by absorbing some of the pressure applied to the corrugated board, or by distributing the applied pressure over a larger surface area.

While the illustrated examples referring to cutting and folding the corrugated board using forming dies having forming blades, in some examples, the corrugated board could be cut, folded, and otherwise assembled using other techniques, for example, by making and assembling the frames by hand.

After cutting and folding the corrugated board, one or more pieces of corrugated board can be secured together to form the frame. As shown in FIG. 2, the pieces could be secured together using adhesive 28 such as glue or epoxy. The pieces could also be secured together with other fasteners such as tape or stiches.

When manufacturing the frame from corrugated board, the corrugated board may be assembled so that the flutes have a particular orientation. For example, the orientation of the flutes may be selected to enhance rigidity or stability of frame. As an example, the vertical sides of frame may have flutes that extend generally vertically. Providing vertically extending flutes may enhance buckling resistance of the furniture.

Referring again to FIG. 8, the method may continue with step 220, which includes securing an upholstery support member to the corrugated board. For example, step 220 may include joining the upholstery support members 36 to the corrugated board 22 using adhesive 44 as shown in FIG. 4. The upholstery support member may be selected to be made from a wood product such as medium density fiberboard, plywood, hardwood, or softwood. The upholstery support member could also be made from a rubber product or other materials such as plastic.

In some examples, the upholstery support member may be formed as a strip of material. Furthermore, the method 200 may include securing the strip of material along an edge of the corrugated board, for example, as shown in FIG. 5.

While step 220 is shown as occurring after step 210 in FIG. 8, in some examples, steps 210 and 220 may occur contemporaneously with one another.

Step 230 includes covering the frame with upholstery. For example, as shown in FIG. 3, step 230 may include covering the frame 20 with fabric 34 and padding 46.

Step 240 includes securing the upholstery to the upholstery support member. For example, step 230 may include securing the upholstery to the upholstery support member using upholstery fasteners such as staples as shown in FIGS. 3 and 4. The upholstery fasteners could also be upholstery tacks or tacking strips.

Steps 230 and 240 generally occur after steps 210 and 220. Furthermore, steps 230 and 240 may occur contemporaneously with each other.

In some examples, the method 200 may also include step 250 of positioning a layer of foam or padding between the upholstery and the upholstery support member. The padding may conceal the upholstery support member, or may help protect the frame. The padding is generally placed over the upholstery support member prior to securing the upholstery to the upholstery support member in step 240. For example, as shown in FIGS. 4 and 5, the padding 46 may be placed over the upholstery support member 36 before covering the frame 20 with the fabric 34.

In some examples, the frame may include a seat or support surface formed from the corrugated board. For example, the seat may include a seat-base or a seat-back for supporting someone sitting on the furniture. Furthermore, the upholstery may include padding over the seat, which may be the same padding used at step 250. In such examples, the method 200 may include step 260 of forming at least one opening in the corrugated board along the seat so as to provide ventilation for the padding. As an example, step 260 may include cutting circular openings 172 in the corrugated board 122 along the seat 170 as shown in FIG. 6.

Step 260 of forming the openings generally occurs before or during assembly of the frame at step 210. However, step 260 could also occur before, during or after any one of steps 210, 220, 230, 240, 250.

While the example shown in FIG. 8 generally refers to furniture manufactured from corrugated board (e.g. as shown in FIGS. 3 and 4), in some examples, the furniture may be made from other types of reinforced board. For example, the reinforced board may have a hollowed core filled with a reinforcement having a honeycomb pattern (e.g. as shown in FIG. 7).

While the above description provides examples of one or more processes or apparatuses, it will be appreciated that other processes or apparatuses may be within the scope of the accompanying claims.

1. A method of manufacturing upholstered furniture, the method comprising:
a) assembling a frame from reinforced board;
b) securing an upholstery support member to the reinforced board;
c) covering the frame with upholstery; and
d) securing the upholstery to the upholstery support member.

2. The method of claim 1, further comprising selecting the upholstery support member to be made from a wood product.

3. The method of claim 2, wherein the wood product is medium-density fiberboard.

4. The method of claim 1, further comprising selecting the upholstery support member to be made from a rubber product.

5. The method of claim 1, wherein the securing step includes securing a strip of material along an edge of the reinforced board.

6. The method of claim 1, wherein the upholstery support member is secured to the portion of the frame using an adhesive.

7. The method of claim 6, wherein the adhesive is glue.

8. The method of claim 1, wherein the upholstery is secured to the upholstery support member using staples.

9. The method of claim 1, further comprising positioning a layer of padding between the upholstery and upholstery support member prior to securing the upholstery to the upholstery support member.

10. The method of claim 1, wherein the frame includes a support surface formed from the reinforced board, and the upholstery includes padding over the support surface, and wherein the method further comprises forming at least one opening in the reinforced board along the support surface so as to provide ventilation to the padding.

11. The method of claim 1, wherein assembling the frame includes cutting and folding the reinforced board.

12. The method of claim 11, wherein cutting and folding the reinforced board includes passing the reinforced board across at least one forming die having at least one forming blade.

13. The method of claim 12, wherein the forming blade is a folding blade for creasing the reinforced board along a fold line.

14. The method of claim 12, wherein the forming blade is a cutting blade for cutting the reinforced board.

15. The method of claim 12, wherein the reinforced board includes:
a) an exterior wall to be covered with the upholstery; and
b) an interior wall opposite the exterior wall;
wherein the reinforced board is passed across the forming die such that the forming blade strikes the interior wall.

16. The method of claim 15, wherein the reinforced board is a corrugated board, and wherein the exterior wall has B-fluting, and the interior wall has C-fluting.

17. The method of claim 15, wherein at least one of the exterior wall and the interior wall has a hollowed core filled with a reinforcement having a honeycomb pattern.

18. The method of claim 12, wherein the forming die includes at least one pressure relief member positioned adjacent to the forming blade.

19. The method of claim 1, wherein the furniture is assembled from a plurality of components having frames made from reinforced board.

20. A piece of upholstered furniture comprising:
a) a frame made from reinforced board;
b) at least one upholstery support member secured to the reinforced board;
c) upholstery covering the frame; and
d) at least one upholstery fastener for securing the upholstery to the upholstery support member.

21. The piece of furniture of claim 20, wherein the upholstery support member is made from a wood product.

22. The piece of furniture of claim 21, wherein the wood product is medium-density fiberboard.

23. The piece of furniture of claim 20, wherein the upholstery support member is made from a rubber product.

24. The piece of furniture of claim 20, wherein the upholstery support member includes a strip of material positioned along an edge of the reinforced board.

25. The piece of furniture of claim 20, wherein the frame includes a support surface formed from the reinforced board, and the upholstery includes padding over the support surface, and the reinforced board has at least one opening along the support surface for providing ventilation to the padding.

26. The piece of furniture of claim 20, further comprising adhesive for securing the upholstery support member to the reinforced board.

27. The piece of furniture of claim 20, wherein the reinforced board is double walled.

28. The piece of furniture of claim 20, wherein the reinforced board is a corrugated board.

29. The piece of furniture of claim 28, wherein the corrugated board includes an exterior wall with a B-fluting and an interior wall with a C-fluting.

30. The piece of furniture of claim 28, wherein the corrugated board includes at least one liner sheet made from a paper-like product having an areal density greater than about 285 g/m².

31. The piece of furniture of claim 28, wherein the corrugated board includes at least one wall with fluting made from a paper-like product having an areal density of less than about 145 g/m².

32. The piece of furniture of claim 20, wherein the reinforced board includes at least one wall having a hollowed core filled with a reinforcement having a honeycomb pattern.

33. The piece of furniture of claim 20, wherein the at least one upholstery fastener includes a plurality of staples.

34. The piece of furniture of claim 20, further comprising a layer of padding positioned between the upholstery and the upholstery support member.

35. A component for use in upholstered furniture, the component comprising:
a) a frame made from reinforced board; and
b) at least one upholstery support member secured to the reinforced board for receiving at least one upholstery fastener so as to secure upholstery to the upholstery support member.

36. The component of claim 35, wherein the upholstery support member is made from a wood product.

37. The component of claim 36, wherein the wood product is medium-density fiberboard.

38. The component of claim 35, wherein the upholstery support member is made from a rubber product.

39. The component of claim 35, wherein the upholstery support member includes a strip of material positioned along an edge of the reinforced board.

40. The component of claim 35, further comprising adhesive for securing the upholstery support member to the reinforced board.

41. The component of claim 35, wherein the reinforced board is double walled.

42. The component of claim 35, wherein the reinforced board is a corrugated board.

43. The component of claim 42, wherein the corrugated board includes an exterior wall with a B-fluting and an interior wall with a C-fluting.

44. The component of claim 42, wherein the corrugated board includes at least one liner sheet made from a paper-like product having an areal density greater than about 285 g/m².

45. The component of claim 42, wherein the corrugated board includes at least one wall with fluting made from a paper-like product having an areal density of less than about 145 g/m².

46. The component of claim 36, wherein the reinforced board includes at least one wall having a hollowed core filled with a reinforcement having a honeycomb pattern.
